(19) United States
(12) Patent Application Publication
(10) Pub. No.: US 2016/0112908 A1
(43) Pub. Date: Apr. 21, 2016

(54) INTER RADIO ACCESS TECHNOLOGY MEASUREMENT BASED POWER CONSERVATION

(71) Applicant: QUALCOMM Incorporated, San Diego, CA (US)

(72) Inventors: Tom CHIN, San Diego, CA (US); Roy Howard DAVIS, Del Mar, CA (US); Ming YANG, San Diego, CA (US)

(21) Appl. No.: 14/708,127

(22) Filed: May 8, 2015

Related U.S. Application Data
(60) Provisional application No. 62/065,554, filed on Oct. 17, 2014.

(51) Int. Cl. H04W 36/00; H04W 36/30

(52) U.S. Cl. CPC H04W 36/0083; H04W 36/30

(57) ABSTRACT

A user equipment (UE) adjusts a rate of performing searches and/or measurements of neighbor cells to conserve resources of the UE. In one instance, the UE independently determines whether to perform the searches and/or measurements of the neighbor cells of first and second RATs based on a signal quality of a serving cell of a first RAT and/or a signal quality of the neighbor cell(s) of the first RAT. The UE avoids performing the searches and/or measurements of the neighbor cell(s) when the signal quality of the serving cell is above a first threshold. The UE selectively performs the searches and/or measurements when the signal quality of the serving cell is above a second threshold and below the first threshold, and the signal quality of the neighbor cell(s) of the first RAT is above the second threshold or a third threshold.

### CROSS-REFERENCE TO RELATED APPLICATION

This application claims the benefit under 35 U.S.C. §119(e) to U.S. Provisional Patent Application No. 62/065,554, entitled “INTER RADIO ACCESS TECHNOLOGY MEASUREMENT BASED POWER CONSERVATION,” filed on Oct. 17, 2014, in the names of CHIN, et al., the disclosure of which is expressly incorporated by reference herein in its entirety.

### BACKGROUND

1. Field

Aspects of the present disclosure relate generally to wireless communication systems, and more particularly, to avoiding or reducing a frequency of performing searches and/or measurements of neighbor cells of a second radio access technology (RAT) based on whether a signal quality of a serving and neighbor cells of a first radio access technology (RAT) meet one or more different thresholds.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method of wireless communication includes independently determining whether to perform searches and/or measurements of neighbor cells of a first radio access technology (RAT) and neighbor cells of a second RAT. The determination is based on a signal quality of a serving cell of the first RAT and/or a signal quality of the neighbor cells of the first RAT.

According to another aspect of the present disclosure, an apparatus for wireless communication includes means for identifying a signal quality of a serving cell of a first radio access technology (RAT) and/or a signal quality of neighbor cells of the first RAT. The apparatus may also include means for independently determining whether to perform searches and/or measurements of the neighbor cells of a first RAT and neighbor cells of a second RAT. The determination is based on a signal quality of a serving cell of the first RAT and/or a signal quality of the neighbor cells of the first RAT.

Another aspect discloses an apparatus for wireless communication and includes a memory and at least one processor coupled to the memory. The processor(s) is configured to independently determine whether to perform searches and/or measurements of neighbor cells of a first radio access technology (RAT) and neighbor cells of a second RAT. The determination is based on a signal quality of a serving cell of the first RAT and/or a signal quality of the neighbor cells of the first RAT.

Yet another aspect discloses a computer program product for wireless communications in a wireless network having a non-transitory computer-readable medium. The computer-readable medium has non-transitory program code recorded thereon which, when executed by the processor(s), causes the processor(s) to independently determine whether to perform searches and/or measurements of neighbor cells of a first radio access technology (RAT) and neighbor cells of a second RAT. The determination is based on a signal quality of a serving cell of the first RAT and/or a signal quality of the neighbor cells of the first RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIGS. 5A and 5B are block diagrams illustrating methods for wireless communication according to aspects of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

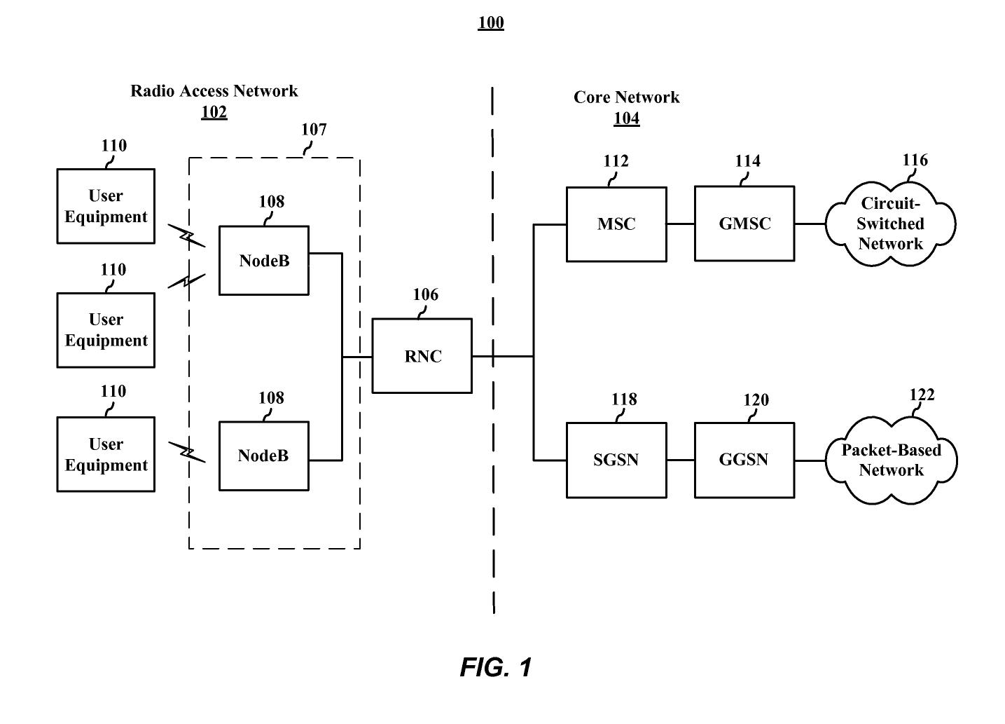

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

General packet radio service (GPRS) is designed to provide packet-data services at speeds higher than those available with standard GSM circuit switched data services. The core network 104 also supports packet-data services with a serving GPRS support node (SGSN) 118 and a gateway GPRS support node (GGSN) 120. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

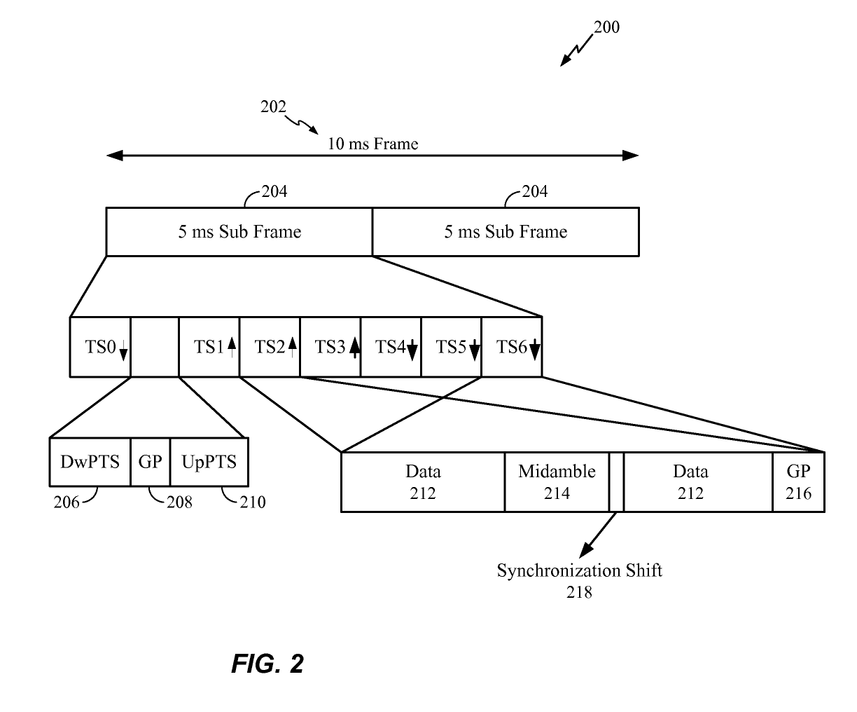

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization Shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

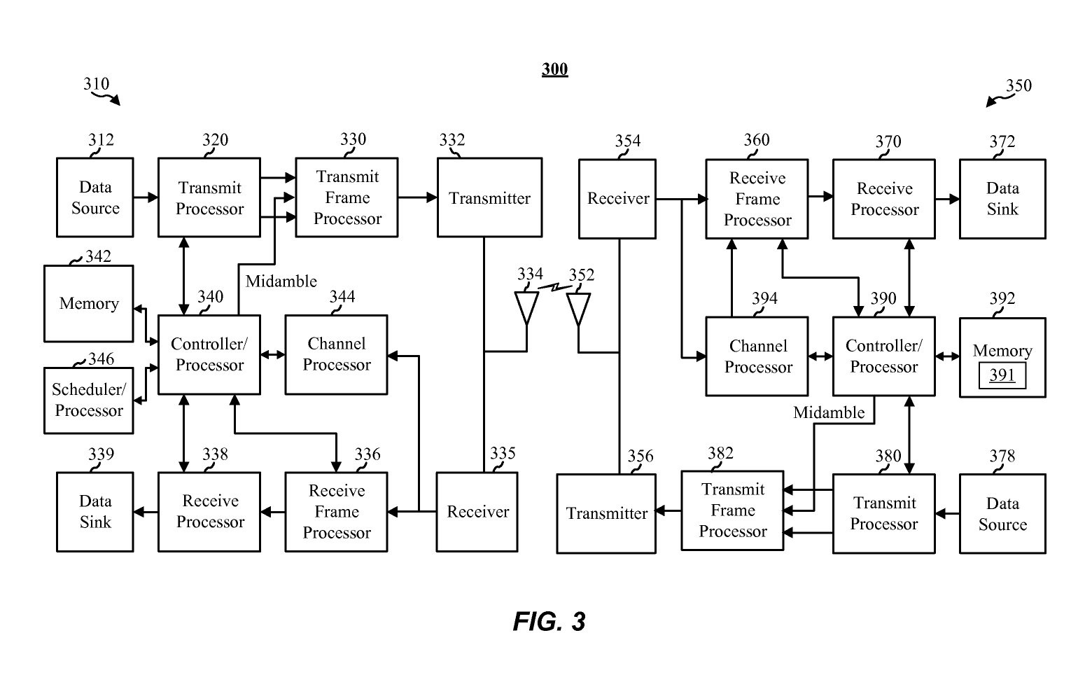

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a search/measurement module 391 which, when executed by the controller/processor 390, configures the UE 350 to determine whether to perform searches and/or measurements according to aspects of the present disclosure. A scheduler/processor 346 at the node B 310 may be used to allocate resources to the UEs and schedule downlink and/or uplink transmissions for the UEs.

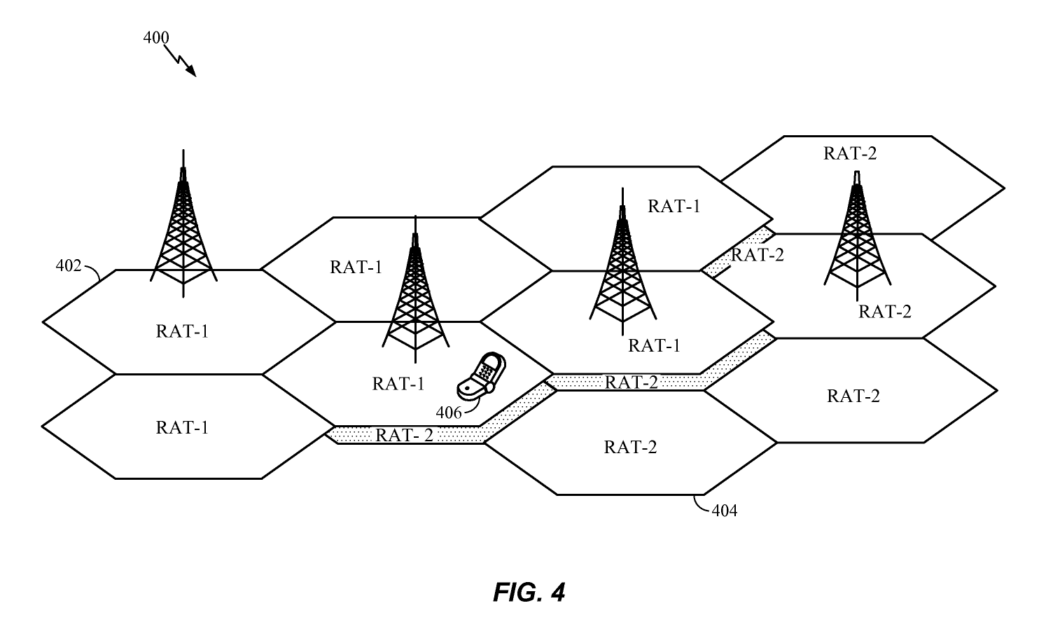

Some networks may be deployed with multiple radio access technologies. FIG. 4 illustrates a network utilizing multiple types of radio access technologies (RATs), such as but not limited to GSM (2G), TD-SCDMA (3G) and LTE (4G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

In one example, the geographical area 400 includes RAT-1 cells 402 and RAT-2 cells 404. In one example, the RAT-1 cells are 2G or 3G cells and the RAT-2 cells are LTE cells. However, those skilled in the art will appreciate that other types of radio access technologies may be utilized within the cells. A user equipment (UE) 406 may move from one cell, such as a RAT-1 cell 402, to another cell, such as a RAT-2 cell 404. The movement of the UE 406 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., 2G/3G) a UE may be specified to perform a measurement of a neighboring cell (such LTE cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

A network indicated serving cell search threshold determines when to perform IRAT measurements, (for example, for reselection from 4G to 3G/2G), and when to perform inter-frequency neighbor cell measurements (e.g., within 4G/LTE). The value of the serving cell search threshold is the same for IRAT measurements and inter-frequency neighbor cell measurements. In particular, the value of the serving cell search threshold is common for equal or lower priority LTE frequencies and lower priority RATS (e.g., 3G and 2G).

In some implementations, when the UE is camped on a serving cell and/or frequency of a first RAT (e.g., fourth generation RAT (4G RAT) or fifth generation radio access technology (5G RAT)), the UE may perform search and measurement procedures for neighbor cells of different RATS (e.g., 2G/3G) and neighbor cells of the first RAT. For example, the UE performs the search and measurement procedures when the signal quality of the serving cell of a first RAT is below the network indicated serving cell search threshold. However, performing the search and measurement procedures for other cells/frequencies of the first and different RATs is an inefficient use of resources (e.g., time) and may waste battery power. The inefficiencies in the use of resources available to the UE are increased when the UE is scheduled to always perform search and/or measurement of lower priority 2G/3G frequencies, which unnecessarily wastes UE battery power.

### Inter Radio Access Technology Measurement Based Power Conservation

Aspects of the present disclosure conserve user equipment (UE) resources by adjusting a frequency of performing searches and/or measurements of neighbor cells of one or more radio access technologies (RATs) that are different from a currently serving RAT. The UE may determine whether (and how frequently) to perform the searches and/or measurements of one or more neighbor cells (of the different RATs) based on a signal quality of the serving cell and a signal quality of one or more neighbor cells of the currently serving RAT. The signal quality of the serving and/or neighbor cell(s) of the currently serving RAT is determined from a current search and measurement.

In one aspect, the UE stops performing searches and/or measurements of cells of the different RAT(s). The UE stops performing searches and/or measurements of the cells of the different RATs when the signal quality of the serving cell and the signal quality of the one or more neighbor cells of the currently serving RAT are above a threshold. The threshold for avoiding the searches and measurements may include a first set of thresholds. For example, the UE only performs searches and/or measurements of neighbor cells of the currently serving RAT when the signal qualities of the serving and neighbor cells are above the threshold.

In another aspect, the UE slows down the searches and/or measurements of cells of the different RAT(s). The UE slows down the searches and/or measurements when the signal quality of the serving cell and the signal quality of the one or more neighbor cells of the currently serving RAT are above another threshold. Similar to the threshold for stopping the searches and measurements, the other threshold may include a second set of thresholds. The threshold for slowing down the searches and measurements may be lower than the threshold for avoiding performing of measurements or avoiding performing of searches. For example, the UE may infrequently perform searches and measurements of the neighbor cells of the different RATs. In this case, the infrequent searches and/or measurements occur when the signal quality of the serving cell and the signal quality of the one or more neighbor cells of the currently serving RAT are above the other threshold.

The search/measurement may be performed independently for each RAT. The search may be performed independently of the measurement and vice versa. For example, the measurement may be performed based on a previous search while the searching is stopped. In one aspect of the disclosure, the UE may slow down the rate of searching and/or rate of performing measurements or stop all searches and/or measurements of neighbor cells/frequencies of the different RAT. The UE may determine whether (and how frequently) to perform the searches and/or measurements of one or more neighbor cells (of different RATs) based on a signal quality of the serving cell and the signal quality of the one or more neighbor cells of the currently serving RAT. The UE independently decides whether to search/measure neighbors cells of the currently serving RAT and whether to search measure neighbors of different RATs. The UE also independently decides whether search rates and whether measurement rates should be adjusted because measuring consumes more resources than searching.

For example, the UE stops performing or selectively performs searches and/or measurements of the neighbor cells based on a level of signal quality of the serving cell and/or the neighbor cells of the currently serving RAT. The level of strength of the serving cell and/or neighbor cells of the currently serving RAT may be determined based on a comparison of the signal quality of the cells to one or more different thresholds. The different thresholds may be tiered thresholds and each tiered threshold or range of tiered thresholds may provide an indication of when the searches and/or measurements are avoided or selectively performed.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc. Signal quality is intended to cover the term signal strength, as well.

In one aspect of the disclosure, the UE may determine whether to avoid performing searches and/or measurements of neighbor cells based on the signal quality of the serving cell of the currently serving RAT (e.g., fourth generation RAT, such as LTE or a fifth generation RAT). The UE makes the determination by comparing the signal quality of the serving cell to a first threshold. The threshold serves as an indication for the level of strength of the serving cell. For example, when the LTE serving cell is very strong (i.e., when the signal quality of the LTE serving cell is above the first threshold), the UE avoids performing the searches and/or measurements of other frequencies of the currently serving RAT and of other RATs. By avoiding searches and/or measurements when the serving cell is very strong, the UE saves battery power and resources that would otherwise be allocated for the searches and/or measurements. Throughput can also be increased by avoiding search/measurement when the serving cell is very strong.

In another aspect of the present disclosure, the UE only searches and/or measures neighbor cells of the currently serving RAT based on the level of strength of the serving cell and the level of strength of the one or more neighbor cells of the currently serving RAT. For example, the UE only performs searches and/or measurements of neighbor cells of a first RAT (e.g., LTE) when the serving cell of the first RAT is strong and the neighbor cell(s) of the first RAT are strong. The UE determines the strengths of the serving and neighbor cells of the first RAT by comparing the signal quality of the serving cell to a second threshold and comparing the signal quality of the neighbor cell(s) of the currently serving RAT to the second threshold or a different threshold (e.g., a third threshold).

If the signal quality of the serving cell of the first RAT is above the second threshold but below the first threshold (i.e., the serving cell is strong) and/or the signal quality of the neighbor cell(s) of the first RAT are above the second/third threshold, the UE performs searches and/or measurements of the neighbor cells of the first RAT. That is the UE only performs searches and/or measurements of the neighbor cells of the first RAT, without searching or measuring other RATs.

If the signal quality of the serving cell of the first RAT is above a fourth threshold but below the second threshold and/or the signal quality of the neighbor cell(s) of the first RAT is above the fourth threshold or a different threshold (e.g., a fifth threshold) but below the second/third threshold the UE stops searching neighbor cells of a second RAT (e.g., 2G/3G). For example, the UE stops searching for a lower priority RAT. Under these conditions, the UE may continue to independently measure the neighbor cells of the second RAT based on a previous search. Alternatively, the UE stops measuring as well as searching. When the UE is in idle mode, the UE searches and measures when waking up. On the other hand, when the UE is in connected mode, the UE searches once and then periodically measures.

Similarly, if the signal quality of the serving cell of the first RAT is above a sixth threshold but below the second threshold and/or the signal quality of the neighbor cell(s) of the first RAT is above the sixth threshold or a different threshold (e.g., a seventh threshold) but below the second/third threshold, the UE stops measuring neighbor cells of a second RAT (e.g., 2G/3G). For example, the UE stops measuring a lower priority RAT. Under these conditions, the UE may continue to independently search the neighbor cells of the second RAT. If the neighbor cell(s) of the first RAT are weak, there may be more incentive to search the lower priority RATs. Thus, in some cases, searching may continue. The sixth threshold may be lower than the fourth threshold and the seventh threshold may be lower than the fifth threshold. That is, under these conditions, the signal quality of the cells of the first RAT is less than the signal quality when only the search of the second RAT is stopped.

In another aspect of the disclosure, the UE reduces the search rate (instead of stopping) of the neighbor cells of the second RAT when the signal quality of the serving cell of the first RAT is below the fourth threshold and/or the signal quality of the neighbor cell(s) of the first RAT is below the fourth/fifth threshold. For example, the UE may slow down the rate of performing searches of the neighbor cells of the second RAT while also performing measurements of the neighbor cells of the second RAT or stop the measurement of the neighbor cells of the second RAT. For example, measurement of the cells of the second RAT may be based on a previous search of the cells of the second RAT.

In yet another aspect of the disclosure, the UE reduces the measurement rate (instead of stopping) of the neighbor cells of the second RAT when the signal quality of the serving cell of the first RAT is below the sixth threshold and/or the signal quality of the neighbor cell(s) of the first RAT is below the sixth/seventh threshold. For example, the UE may slow down the measurement rate of the neighbor cells of the second RAT while also performing searches of the neighbor cells of the second RAT or stopping the searches of the neighbor cells of the second RAT. For example, measurement of the cells of the second RAT may be based on a previous search of the cells of the second RAT.

In one aspect of the disclosure, the first RAT (or currently serving RAT) is a fourth or fifth generation RAT (e.g., LTE) and the second RAT is a second/third generation RAT (e.g., GSM/TD-SCDMA). The serving cell may have a same or different priority than the neighbor cells. For example, the first RAT may have a higher priority than the second RAT.

In yet another aspect of the disclosure, the UE performs searches and/or measurements of neighbor cells of the second RAT when the serving cell of the first RAT is weak or not so strong. For example, to determine when the LTE serving cell is weak, the UE compares the signal quality of the LTE serving cell to an eighth threshold. If the signal quality of the LTE serving is below the eighth threshold, (i.e., the LTE serving cell is weak) the UE performs regular searches and/or measurements of the neighbor cells of the second RAT. The eighth threshold may be lower than the first, second, third, fifth, sixth and seventh thresholds.

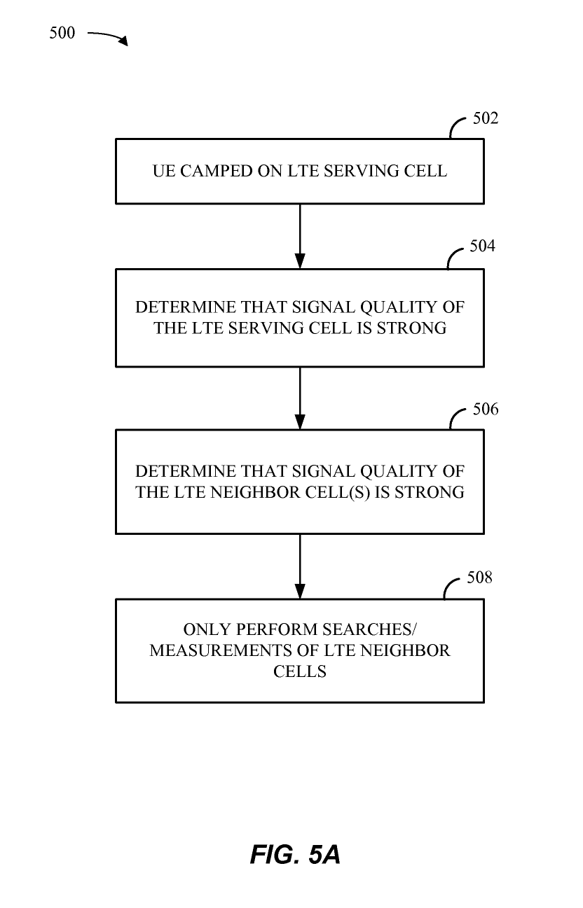

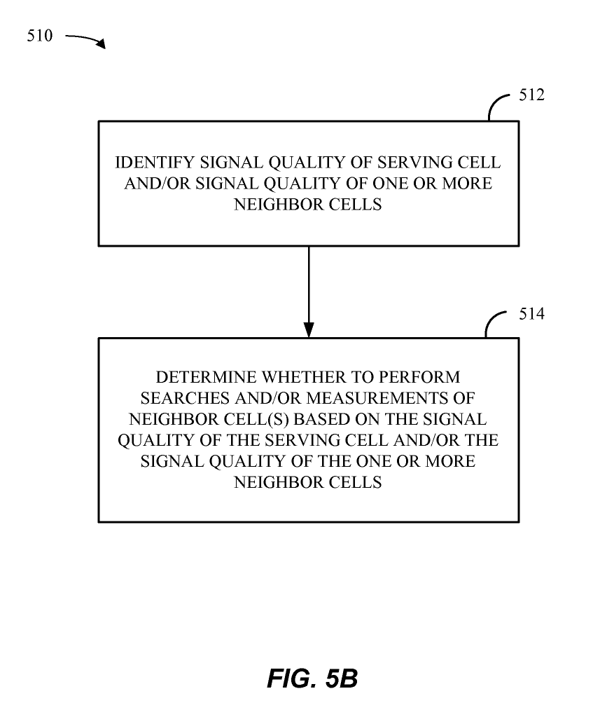

FIG. 5A illustrates a wireless communication method 500 according to one aspect of the present disclosure. At block 502, the UE is camped on an LTE serving cell. In one aspect of the disclosure, the UE may determine whether to avoid performing searches and/or measurements of neighbor cells based on the signal quality of the serving cell of a RAT (e.g., fourth generation RAT, such as LTE). For example, at block 504, the UE determines that the signal quality of the LTE serving cell is strong by comparing the signal quality of the LTE serving cell to a LTE serving threshold. The LTE serving cell is deemed strong when the signal quality of the LTE serving cell is greater than the LTE serving threshold.

At block 506, the UE determines that the LTE neighbor cells are strong when the signal quality of one or more LTE neighbor cells is greater than a LTE neighbor cell threshold. At block 508, the UE performs searches and/or measurements of only the LTE neighbor cells when the LTE serving and neighbor cells are strong. In this case, the UE stops performing searches and or measurements of 2G/3G neighbor cells.

FIG. 5B shows a wireless communication method 510 according to one aspect of the disclosure. A UE identifies a signal quality of a serving cell of the first RAT and/or a signal quality of one or more neighbor cells of the first RAT, as shown in block 512. The UE independently determines whether to perform searches and/or measurements of the neighbor cells of the first and the second RATs based only on the signal quality of the serving cell of the first RAT and/or the signal quality of the neighbor cells of the first RAT, as shown in block 514.

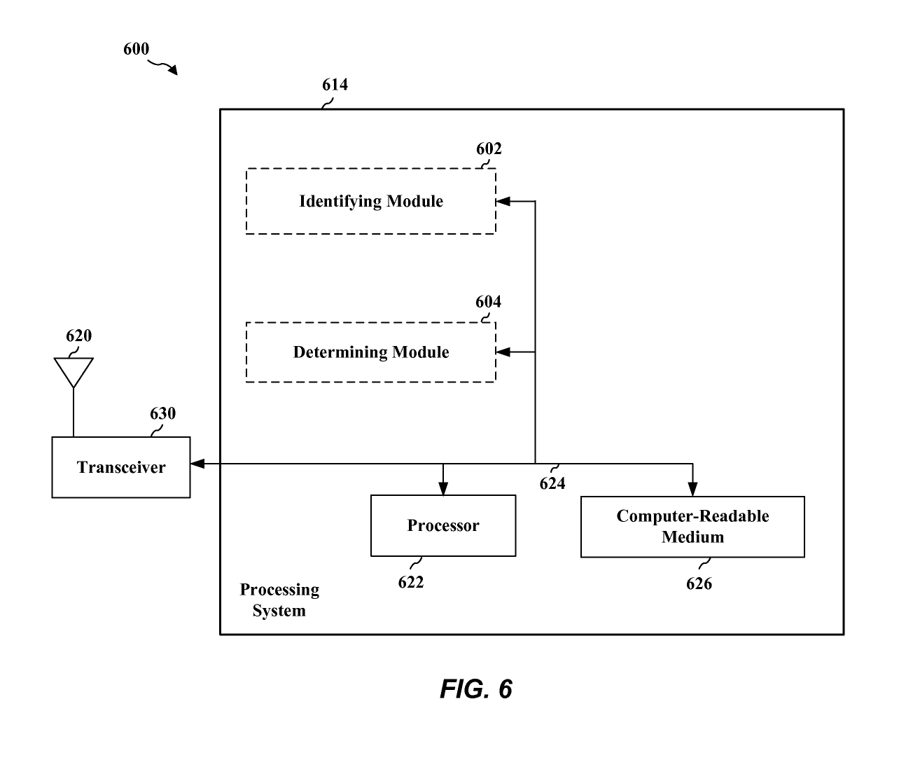

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622 the modules 602, 604 and the non-transitory computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatuses over a transmission medium. The processing system 614 includes a processor 622 coupled to a non-transitory computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes an identifying module 602 for identifying a signal quality of a serving cell and/or a signal quality of one or more neighbor cells. The processing system 614 includes a determining module 604 for determining whether to perform searches and/or measurements of the neighbor cells of first and second RATs. The modules may be software modules running in the processor 622, resident/stored in the computer-readable medium 626, one or more hardware modules coupled to the processor 622, or some combination thereof The processing system 614 may be a component of the UE 350 and may include the memory 392, and/or the controller/processor 390.

In one configuration, an apparatus such as a UE is configured for wireless communication including means for identifying. In one aspect, the identifying means may be the antennas 352/620, the receiver 354, the transceiver 630, the channel processor 394, the receive frame processor 360, the receive processor 370, the controller/processor 390, the memory 392, the search/measurement module 391, the identifying module 602, and/or the processing system 614 configured to perform the aforementioned means. The UE is also configured to include means for determining In one aspect, the determining means may be the controller/processor 390, the memory 392, search/measurement module 391, the determining module 604 and/or the processing system 614 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system have been presented with reference to LTE, TD-SCDMA, 5G (fifth generation) and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
independently determining whether to perform searches and/or measurements of neighbor cells of a first radio access technology (RAT) and neighbor cells of a second RAT based at least in part on a signal quality of a serving cell of the first RAT and/or a signal quality of the neighbor cells of the first RAT.

2. The method of claim 1, further comprising reducing a rate of performing searches of the neighbor cells of the second RAT when the signal quality of the serving cell is above a first threshold and the signal quality of the neighbor cells of the first RAT is above a second threshold.

3. The method of claim 1, further comprising reducing a rate of performing measurements of the neighbor cells of the second RAT when the signal quality of the serving cell is above a first threshold and the signal quality of the neighbor cells of the first RAT is above a second threshold.

4. The method of claim 1, further comprising avoiding performing of searches of the neighbor cells of the second RAT when the signal quality of the serving cell is above a first threshold and the signal quality of the neighbor cells of the first RAT is above a second threshold.

5. The method of claim 1, further comprising avoiding performing of measurements of the neighbor cells of the second RAT when the signal quality of the serving cell is above a first threshold and the signal quality of the neighbor cells of the first RAT is above a second threshold.

6. An apparatus for wireless communication, comprising:
means for identifying a signal quality of a serving cell of a first radio access technology (RAT) and/or a signal quality of neighbor cells of the first RAT; and
means for independently determining whether to perform searches and/or measurements of the neighbor cells of a first RAT and neighbor cells of a second RAT based at least in part on the signal quality of the serving cell of the first RAT and/or the signal quality of the neighbor cells of the first RAT.

7. The apparatus of claim 6, further comprising means for reducing a rate of performing searches of the neighbor cells of the second RAT when the signal quality of the serving cell is above a first threshold and the signal quality of the neighbor cells of the first RAT is above a second threshold.

8. The apparatus of claim 6, further comprising means for reducing a rate of performing measurements of the neighbor cells of the second RAT when the signal quality of the serving cell is above a first threshold and the signal quality of the neighbor cells of the first RAT is above a second threshold.

9. The apparatus of claim 6, further comprising means for avoiding performing of searches of the neighbor cells of the second RAT when the signal quality of the serving cell is above a first threshold and the signal quality of the neighbor cells of the first RAT is above a second threshold.

10. The apparatus of claim 6, further comprising means for avoiding performing of measurements of the neighbor cells of the second RAT when the signal quality of the serving cell is above a first threshold and the signal quality of the neighbor cells of the first RAT is above a second threshold.

11. An apparatus for wireless communication, comprising:
a memory; and
at least one processor coupled to the memory and configured:
to independently determine whether to perform searches and/or measurements of neighbor cells of a first radio access technology (RAT) and neighbor cells of a second RAT based at least in part on a signal quality of a serving cell of the first RAT and/or a signal quality of the neighbor cells of the first RAT.

12. The apparatus of claim 11, in which the at least one processor is further configured to reduce a rate of performing searches of the neighbor cells of the second RAT when the signal quality of the serving cell is above a first threshold and the signal quality of the neighbor cells of the first RAT is above a second threshold.

13. The apparatus of claim 11, in which the at least one processor is further configured to reduce a rate of performing measurements of the neighbor cells of the second RAT when the signal quality of the serving cell is above a first threshold and the signal quality of the neighbor cells of the first RAT is above a second threshold.

14. The apparatus of claim 11, in which the at least one processor is further configured to avoid performing searches of the neighbor cells of the second RAT when the signal quality of the serving cell is above a first threshold and the signal quality of the neighbor cells of the first RAT is above a second threshold.

15. The apparatus of claim 11, in which the at least one processor is further configured to avoid performing measurements of the neighbor cells of the second RAT when the signal quality of the serving cell is above a first threshold and the signal quality of the neighbor cells of the first RAT is above a second threshold.

16. A non-transitory computer-readable medium having program code recorded thereon, the program code comprising:
program code to independently determine whether to perform searches and/or measurements of neighbor cells of a first radio access technology (RAT) and neighbor cells of a second RAT based at least in part on a signal quality of a serving cell of the first RAT and/or a signal quality of the neighbor cells of the first RAT.

17. The computer-readable medium of claim 16, further comprising program code to reduce a rate of performing searches of the neighbor cells of the second RAT when the signal quality of the serving cell is above a first threshold and the signal quality of the neighbor cells of the first RAT is above a second threshold.

18. The computer-readable medium of claim 16, further comprising program code to reduce a rate of performing measurements of the neighbor cells of the second RAT when the signal quality of the serving cell is above a first threshold and the signal quality of the neighbor cells of the first RAT is above a second threshold.

19. The computer-readable medium of claim 16, further comprising program code to avoid performing searches of the neighbor cells of the second RAT when the signal quality of the serving cell is above a first threshold and the signal quality of the neighbor cells of the first RAT is above a second threshold.

20. The computer-readable medium of claim 16, further comprising program code to avoid performing measurements of the neighbor cells of the second RAT when the signal quality of the serving cell is above a first threshold and the signal quality of the neighbor cells of the first RAT is above a second threshold.
